(19) United States
(12) Patent Application Publication
(10) Pub. No.: US 2025/0196837 A1
(43) Pub. Date: Jun. 19, 2025

(54) METHOD FOR PREDICTING AN EXPECTED DECELERATION OF AT LEAST ONE VEHICLE, AND CORRESPONDING SYSTEM

(71) Applicant: Faiveley Transport Italia S.P.A., Piossasco (Torino) (IT)

(72) Inventors: Luc Imbert, Torino (IT); Mauro Filoni, Galatone (Lecce) (IT); Frea Matteo, Cantalupa (Torino) (IT)

(73) Assignee: Faiveley Transport Italia S.P.A., Piossasco (Torino) (IT)

(21) Appl. No.: 19/067,190

(22) Filed: Feb. 28, 2025

Related U.S. Application Data
(63) Continuation-in-part of application No. PCT/IB2023/058666, filed on Sep. 1, 2023.

(30) Foreign Application Priority Data
Sep. 1, 2022 (IT) 102022000017958

(51) Int. Cl. B60T 17/22; G06N 3/084

(52) U.S. Cl. CPC B60T 17/228; G06N 3/084

(57) ABSTRACT

A computer-implemented method for predicting an expected deceleration of at least one vehicle, particularly at least one rail vehicle, the method comprising the steps of providing as input to a neural network at least one braking datum related to the performance of a braking system of the at least one vehicle, at least one environmental datum related to environmental conditions of a route along which the vehicle moves, at least one vehicle datum related to the structure of the at least one vehicle and through the neural network, predicting an expected deceleration value of the at least one vehicle, based on the at least one braking datum, at least one environmental datum and at least one vehicle datum.

### CROSS-REFERENCE TO RELATED APPLICATIONS

This application is a continuation-in-part of International Application PCT/IB2023/058666 filed 1 Sep. 2023, which claims priority to IT102022000017958 filed 1 Sep. 2022, the entire disclosures of which are hereby incorporated by reference herein.

### BACKGROUND

### Technical Field

The present invention is, in general, in the field of vehicles; in particular, the invention relates to a computer-implemented method for predicting an expected deceleration of at least one vehicle, and a corresponding system.

### Discussion of Art

In the following the prior art will be described with particular reference to the rail vehicle industry; however, what is described in the following may also apply similarly to vehicles in additional industries, where applicable.

The rail industry aspires to new concepts of rolling stock management on networks. These new management concepts aim to increase line capacity, rail vehicle reliability, and resistance to changing environmental conditions.

The braking performance of a rail vehicle may be impaired due to adverse environmental conditions. Disadvantageously, the impact of environmental conditions may only be limited in part by existing braking systems.

### BRIEF DESCRIPTION

One object of the present invention is therefore to provide a solution that enables the performance of a vehicle to be predicted, particularly with regard to the vehicle's deceleration performance. This prediction may be used to improve the performance of a vehicle braking system even under the worst environmental conditions. For example, the vehicle deceleration performance prediction may be used for:
reducing the distance of moving block functions (“moving block train”), thus increasing the capacity of the line;
facilitating the integration of automated vehicle operations through the provision of information that in the prior art was provided manually by the driver; and
enabling information to be provided to the infrastructure manager related to the achievable deceleration conditions on the route/track.

The aforesaid and other objects and advantages are achieved, according to one aspect of the invention, by a computer-implemented method for predicting an expected deceleration of at least one vehicle having the features defined in claim 1, and according to a further aspect by a system for predicting an expected deceleration of at least one vehicle having the features defined in claim 10. Preferred embodiments of the invention are defined in the dependent claims, the content of which is to be understood as an integral part of the present description.

### BRIEF DESCRIPTION OF THE DRAWINGS

The functional and structural features of some preferred embodiments of a system for predicting an expected deceleration of at least one vehicle and a computer-implemented method for predicting an expected deceleration of at least one vehicle according to the invention will now be described. Reference is made to the accompanying drawings, wherein:

FIG. 1 illustrates an exemplifying neural network that may be used in a computer-implemented method for predicting an expected deceleration of at least one vehicle according to the invention;

FIG. 2 illustrates two exemplifying activation functions of the neural network;

FIG. 3 illustrates the states of a neuron in a “feed-forward” structure; and

FIG. 4 illustrates an exemplifying vehicle comprising a computer provided to perform a method for predicting an expected deceleration according to an embodiment of the present invention.

### DETAILED DESCRIPTION

Before explaining in detail a plurality of embodiments of the invention, it should be clarified that the invention is not limited in its application to the design details and configuration of the components presented in the following description or illustrated in the drawings. The invention may assume other embodiments and be implemented or constructed in practice in different ways. It should also be understood that the phraseology and terminology have a descriptive purpose and should not be construed as limiting. The use of “include” and “comprise” and the variations thereof are intended to cover the elements set out below and the equivalents thereof, as well as additional elements and the equivalents thereof.

Referring by way of example to FIG. 4, the following describes a first embodiment of a computer-implemented method for predicting an expected deceleration of at least one vehicle V, particularly at least one rail vehicle.

The method comprises the following steps:
Step a): providing as input to a neural network 100 at least one braking datum 102 related to the performance of a braking system of the at least one vehicle, at least one environmental datum 104 related to environmental conditions of a route along which the vehicle moves, at least one vehicle datum 106 related to the structure of the at least one vehicle V; and
Step b): through said neural network 100, predicting/determining an expected deceleration value 108 of the at least one vehicle V, based on said at least one braking datum 102, at least one environmental datum 104 and at least one vehicle datum 106.

The data 102, 104, 106 provided to the neural network in step a) were selected because they were capable of having an influence on the outcome, i.e., vehicle deceleration.

In other words, the at least one braking datum 102 may indicate the response of the braking system of the vehicle, as well as the potential state of degradation of the braking system and the use of special brakes. For example, the special brakes may comprise at least one of an electrodynamic brake, a magnetic track brake (MTB), a sanding means, an eddy current brake, etc.

The at least one environmental datum 104 is able to indicate the environmental conditions in which the vehicle moves.

The at least one vehicle datum 106 may indicate vehicle features that may affect the deceleration of the vehicle, and consequently the braking distance.

Preferably, the neural network 100 may comprise a feed-forward structure.

A feed-forward neural network is a structure in which the layers do not form a ring, but information flows from the input layer to the hidden layer and to the output layer. This structure is relatively simple and requires limited computing power, making it particularly suitable for implementation in a real-time system such as a control unit of a braking system.

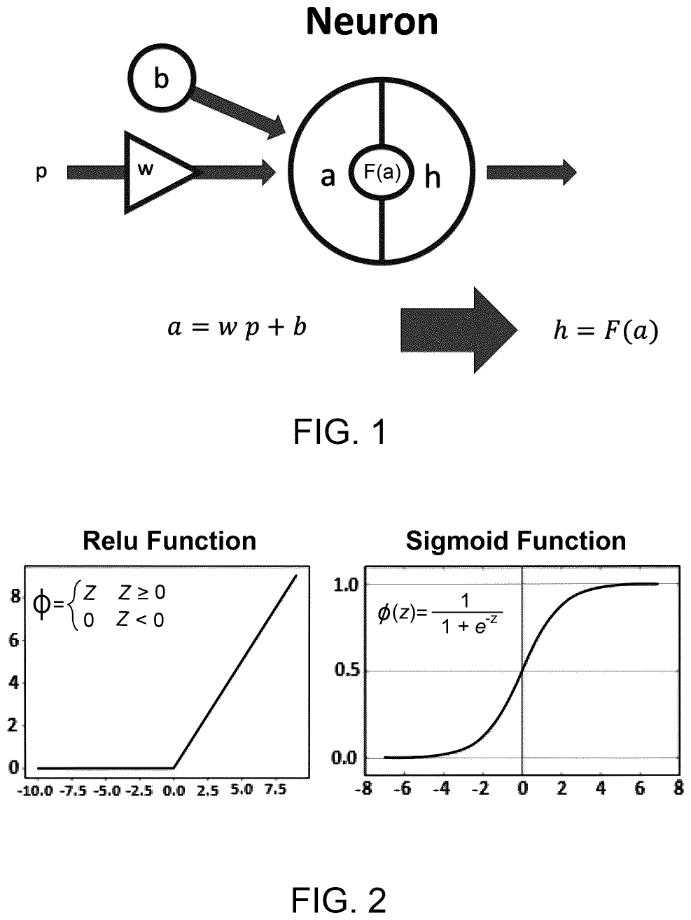

Referring to the exemplifying neural network shown in FIG. 1, the following is an exemplifying definition of a neuron-based artificial intelligence structure.

The input of the neuron a is a linear function, with b the bias, w the weight, p the data input and h the output of the neuron. The output is the same as the activation function:

$$a = wp + b \\ h = F ( a )$$

For example, the activation function may be of two types: sigmoid or rectifier.

Due to their features, both have inherent advantages:
the sigmoid-type activation function allows more complex data structures and has regular output, avoiding value jumps;
the rectifier-type activation function (Relu) requires less calculation.

Two graphs are illustrated in FIG. 2. The left graph shows a rectifier-type activation function. The right graph shows a sigmoid-type activation function.

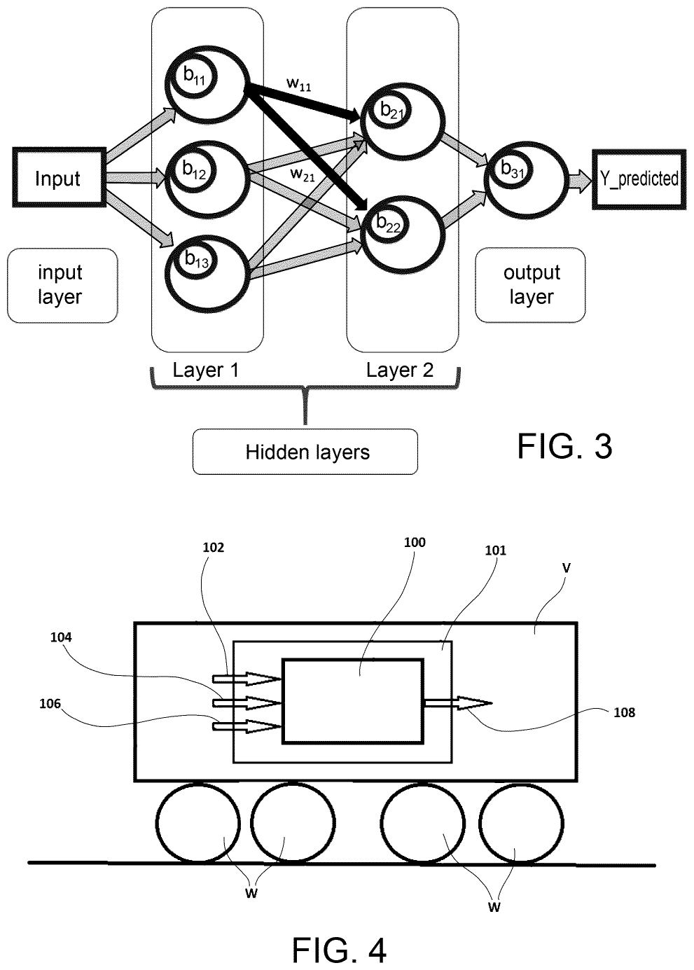

Referring to FIG. 3, the neuron in a feed-forward structure may be represented with an input layer, hidden layers and an output layer.

Preferably, the computer-implemented method for predicting an expected deceleration of at least one vehicle, particularly at least one rail vehicle, may comprise, prior to steps a) and b), performing training of the neural network.

In such a case, the neural network training may comprise:
providing as input to said neural network at least one braking datum, at least one environmental datum, at least one vehicle datum, and an expected deceleration value that is a function of said at least one braking datum, at least one environmental datum, and at least one vehicle datum;
determining the value of at least one parameter of said neural network according to the at least one braking datum, at least one environmental datum, at least one vehicle datum and expected deceleration value received.

The expected deceleration value that is a function of said at least one braking datum, at least one environmental datum and at least one vehicle datum thus represents the known expected deceleration value (e.g., a measured expected deceleration value that may be derived, for example, from previous experimental measurements) that is obtained with said at least one braking datum, at least one environmental datum and at least one vehicle datum.

Preferably, said training is based on a “back-propagation” algorithm.

In other words, the feed-forward neural network may be trained with a back-propagation algorithm to check the consistency of the output (the determination of the vehicle deceleration). The weights and biases (parameters) are frozen at the end of training, once the output results are accurate.

Once the vehicle deceleration is predicted, this value may also be transmitted to a control means comprised in the vehicle or to a remote infrastructure manager.

Preferably, said at least one braking datum 102 related to the performance of a braking system of the at least one vehicle may comprise at least one of the following types of data:
at least one deceleration datum indicative of a deceleration value of at least one wheel W or at least one axle of the at least one vehicle;
at least one datum indicative of the number of wheels W in the skidding phase of the at least one vehicle;
at least one datum indicative of the deceleration of the at least one vehicle in an initial phase of braking;
at least one datum indicative of the actuation speed of at least one braking means of the braking system;
at least one datum indicative of the skidding speed of the at least one wheel or the at least one axle of the at least one vehicle;
at least one datum indicative of a steady state value of at least one braking means of the braking system;
at least one datum indicative of an activation of a sanding means of the at least one vehicle;
at least one datum indicative of an activation of a magnetic braking pad, MTB, of the at least one vehicle;
at least one datum indicative of an activation of a system/function arranged to compensate for a missed expected deceleration value;
at least one datum indicative of the presence of a malfunctioning braking means of the braking system;
at least one datum indicative of a number of activations over time of an exhaust valve associated with at least one braking means of the braking system of the at least one vehicle.

The steady state value of the at least one braking means of the braking system may be understood as the value at which the required braking force has been reached, after transients (e.g., in a pneumatic braking system, the transient corresponds to the time it takes to bring the brake cylinder to the nominal pressure).

Preferably, said at least one environmental datum 104 related to environmental conditions of a route along which the vehicle moves may comprise at least one of the following types of data:
at least one image datum or at least one video datum of the route (e.g., one acquired image or video of the route);
at least one temperature datum indicative of a temperature along the route;
at least one rainfall datum indicative of the presence of rain along the route;
at least one moisture datum indicative of a moisture level along the route;
at least one adhesion datum indicative of a level of adhesion along the route;
at least one route datum indicative of a profile of the route.

Preferably, said at least one vehicle datum 106 related to the structure of the at least one vehicle may comprise at least one of the following types of data:
at least one nominal deceleration datum indicative of a nominal deceleration value of the at least one vehicle;
at least one wheel or axle datum, indicative of the number of wheels or axles of the at least one vehicle;
at least one sanding means datum, indicative of the number of sanding means of the at least one vehicle;
at least one datum of magnetic pads, indicative of the number of MTB magnetic braking pads of the at least one vehicle;
at least one anti-skid system datum, indicative of the fact that the anti-skid system, WSP, acts per vehicle bogie or per vehicle axle;
at least one datum of presence of deceleration compensation, indicative of the fact that the vehicle comprises a missed-deceleration compensation system/function of the at least one vehicle.

Clearly, the various types of braking data 102 related to the performance of a braking system, the various types of environmental data related to environmental conditions of a route along which the vehicle moves, and the various types of vehicle data 106 related to the structure of the at least one vehicle may be combined in any mode. Some possible combinations are given below by way of example.

Preferably, in an example embodiment, the at least one braking datum 102 related to the performance of a braking system of the at least one vehicle may comprise at least one datum indicative of a skidding speed of the at least one wheel or axle of the at least one vehicle, the at least one environmental data 104 related to environmental conditions of a route along which the vehicle moves may comprise at least one adhesion datum indicative of a level of adhesion along the route, and the at least one vehicle datum 106 related to the structure of the at least one vehicle may comprise at least one wheel or axle data indicative of the number of wheels or axles of the at least one vehicle. This example is mainly aimed at monitoring the level of adhesion and the negative impact on deceleration it may have on the various wheels of the vehicle.

In a further example, preferably, the at least one braking datum 102 related to the performance of a braking system of the at least one vehicle may comprise at least one datum indicative of the number of wheels in the skidding phase of the at least one vehicle, the at least one environmental datum 104 related to environmental conditions of a route along which the vehicle is moving may comprise at least one adhesion datum indicative of a level of adhesion along the route, and the at least one vehicle datum 106 related to the structure of the at least one vehicle may comprise at least one anti-skid system datum indicative of the fact that an anti-skid system, WSP, acts per vehicle bogie or per vehicle axle. For example, the at least one vehicle datum 106 related to the structure of the at least one vehicle may additionally comprise at least one datum of presence of deceleration compensation, indicative of the fact that the vehicle comprises a missed-deceleration compensation system/function of the at least one vehicle. This example is mainly aimed at monitoring the level of adhesion between the various wheels of the vehicle and the positive impact on deceleration that may be generated by a missed-deceleration compensation system/function of the at least one vehicle.

In yet another example, preferably, the at least one braking datum 102 related to the performance of a braking system of the at least one vehicle may comprise at least one datum indicative of a steady state value of the at least one braking means of the braking system and at least one datum indicative of the presence of a malfunctioning braking means of the braking system, the at least one environmental datum 104 related to environmental conditions of a route along which the vehicle moves may comprise at least one of any of the data items in the above list, and the at least one vehicle datum 106 related to the structure of the at least one vehicle may comprise at least one of any of the data items in the above list. This example is aimed primarily at monitoring the condition of the braking system and the negative impact on the deceleration that a malfunctioning braking means may have.

Preferably, when there is a plurality of braking data types 102 related to the performance of a braking system of the at least one vehicle, the braking data of each type may respectively undergo a data consolidation procedure before being provided to the neural network.

For example, if 100 braking data are present, including 50 data indicative of the actuation speed of the at least one braking means of the braking system and 50 data indicative of the skidding speed of the at least one wheel or the at least one axle of the at least one vehicle, before being provided to the neural network, the 50 data indicative of the actuation speed of the at least one braking means of the braking system may be subjected to their own data consolidation procedure, and the 50 data indicative of the skidding speed of the at least one wheel or the at least one axle of the at least one vehicle may be subjected to their own data consolidation procedure.

Preferably, when there is a plurality of environmental data types 104 related to environmental conditions of a route along which the vehicle moves, the environmental data of each type may respectively undergo a data consolidation procedure before being provided to the neural network.

For example, if there are 100 environmental data, including 50 temperature data indicative of a temperature along the route and 50 rainfall data indicative of the presence of rain along the route, before being provided to the neural network, the 50 temperature data may be subjected to their own data consolidation procedure and the 50 rainfall data may be subjected to their own data consolidation procedure.

Preferably, when there is a plurality of vehicle data types 106 related to the structure of at least one vehicle, the vehicle data of each type may respectively undergo a data consolidation procedure before being provided to the neural network.

For example, if there are 100 vehicle data, including 50 wheel or axle data and 50 sanding means data, before being provided to the neural network, the 50 wheel or axle data may undergo their own data consolidation procedure and the 50 sanding means data may undergo their own data consolidation procedure.

Preferably, the data consolidation procedure may comprise at least one among:
the determination of an overall sum of the data, the determination of an average of the data, the determination of an absolute minimum among the data, the determination of an absolute maximum among the data.

For example, the data may be consolidated to obtain a vector from an original data matrix of the time series. This consolidation phase represents the preliminary analysis of the data. The consolidation for environmental data may be more advanced in the case of raw video streaming wherein contaminant recognition is used, such as defined in “WO2021100003”. The choice of calculation type depends on the properties of the input data.

Preferably, the at least one braking datum 102 related to the performance of a braking system of the at least one vehicle, the at least one environmental datum 104 related to the environmental conditions of a route along which the vehicle moves and the at least one vehicle datum 106 related to the structure of the at least one vehicle may be correlated by a time variable. Such a time variable may also be provided or known to the neural network, which may in turn correlate the at least one braking data 102 related to the performance of a braking system of the at least one vehicle, the at least one environmental datum 104 related to environmental conditions of a route along which the vehicle moves and the at least one vehicle datum 106 related to the structure of the at least one vehicle received at the input.

In a further aspect, the present invention relates to a system for predicting an expected deceleration of at least one vehicle, particularly at least one rail vehicle, comprising at least one computer arranged to carry out the method according to any of the preceding claims.

For example, the computer 101 may comprise at least one control means such as a processor, microprocessor, controller, microcontroller, FPGA, PLC, control unit, control box, or the like.

Preferably, said computer may be arranged to receive, from a communication means of the at least one vehicle, the at least one braking datum related to the performance of a braking system of the at least one vehicle, the at least one environmental datum related to the environmental conditions of a route along which the vehicle moves and the at least one vehicle datum related to the structure of the at least one vehicle, to be provided to the neural network.

The communication means may be, for example, a vehicle's CAN network.

Preferably, said computer is arranged to receive, from a control means of an additional vehicle moving along the route, the at least one braking datum related to the performance of a braking system of the at least one vehicle, the at least one environmental datum related to the environmental conditions of a route along which the vehicle moves and the at least one vehicle datum related to the structure of the at least one vehicle, to be provided to the neural network.

Preferably, said computer is arranged to receive, from a control system of the at least one vehicle, the at least one braking datum related to the performance of a braking system of the at least one vehicle, the at least one environmental datum related to the environmental conditions of a route along which the vehicle moves and the at least one vehicle datum related to the structure of the at least one vehicle, to be provided to the neural network. The at least one braking datum related to the performance of a braking system of the at least one vehicle, the at least one environmental datum related to the environmental conditions of a route along which the vehicle moves and the at least one vehicle datum related to the structure of the at least one vehicle may be generated by the control system as a function of a predetermined adhesion map.

An adhesion map may be understood as the correspondence between a geographic location on a route (e.g., railroad) and the relative wheel adhesion value and rolling surface (e.g., rail of the route) available.

Preferably, the at least one vehicle may comprise at least one railway vehicle. Otherwise, the vehicles may also be more than one, and they may be associated with one another in order to form a convoy of vehicles, such as a railway convoy.

Preferably, however, the present invention may also be applicable to any type of vehicle. This may include, for example, railway vehicles/trains, road vehicles, a car, a truck (for example a highway semi-trailer truck, a mining truck, a truck for transporting timber or the like), or the like, and the route may be, for example, a track, a road or a trail.

A real-time example embodiment applicable to a railway vehicle or train is described below.

On a vehicle, for example a railway train comprising a plurality of railway vehicles, the deep (e.g. “feed-forward”) neural network may be fed with input data analyzed in advance to generate a prediction of vehicle deceleration. Training may be done offline by providing input data acquired during vehicle commissioning and comparing the vehicle deceleration produced by the neural network with the actual average vehicle deceleration based on measurements.

The trained neural network may be incorporated into the braking control system to provide a prediction of the train deceleration.

The neural network may be used in 4 vehicle architectures, depending on the origin of the data used to make the prediction.

With the local architecture, each vehicle braking system control unit may calculate the expected vehicle deceleration based on locally available data.

With the established architecture, a vehicle braking system control unit may determine the expected deceleration of the vehicle based on data shared on a communication means (e.g., a bus of the braking system) from all other control units of the braking system of the vehicle.

With data from the previous vehicle, a control unit of a braking system may calculate the expected deceleration of the vehicle based on data shared by a control means acting as a control system agent of the vehicle, TCMS, from the previous vehicle.

With the vehicle data from the adhesion map, a control unit may calculate the expected deceleration of the train/rail vehicle based on shared data from the TCMS originating from an adhesion map.

Thus, the advantage achieved is that of having provided a solution that makes it possible to predict the performance of a vehicle, particularly in terms of the vehicle's deceleration performance. The prediction is usable to be able to improve the performance of a braking system even under the worst environmental conditions.

Various aspects and embodiments of a computer-implemented method for predicting an expected deceleration of at least one vehicle and a system for predicting an expected deceleration of at least one vehicle according to the invention have been described. It is understood that each embodiment may be combined with any other embodiment. Moreover, the invention is not limited to the embodiments described, but may be varied within the scope defined by the appended claims.

Once the vehicle deceleration is predicted, this value may also be transmitted to a control means in the vehicle (e.g., a vehicle control circuit) or to a remote infrastructure manager. Regarding the former, the vehicle control circuit may be configured to control the vehicle responsive to the predicted expected vehicle deceleration, e.g., the vehicle is accelerated and/or braked based at least in part on the predicted expected vehicle deceleration (that is, the vehicle is controlled based on the predicted expected vehicle deceleration and possibly other factors). Regarding the latter, the remote infrastructure manager may be configured to control the movement and/or scheduling of plural separate vehicles or vehicles system based in part on the predicted expected vehicle deceleration, e.g., a second, trailing vehicle may be controlled to not be allowed to travel as close to a first, leading vehicle if the predicted expected vehicle deceleration indicates a relatively very fast deceleration, whereas the second, trailing vehicle may be controlled to be allowed to travel closer to the first, leading vehicle if the predicted expected vehicle deceleration indicates a relatively very slow deceleration. Thus, in embodiments, a method may comprise: providing as input to a neural network at least one braking datum related to performance of a braking system of at least one vehicle, at least one environmental datum related to environmental conditions of a route along which the vehicle moves, at least one vehicle datum related to the structure of the at least one vehicle; through the neural network, predicting an expected deceleration value of the at least one vehicle, based on the at least one braking datum, the at least one environmental datum, and the at least one vehicle datum; and controlling the at least one vehicle based at least in part on the expected deceleration value that is predicted.

1. A computer-implemented method for predicting an expected deceleration of at least one vehicle, particularly at least one railway vehicle, comprising the steps of:
a) providing as input to a neural network (100) at least one braking datum (102) related to performance of a braking system of the at least one vehicle, at least one environmental datum (104) related to environmental conditions of a route along which the vehicle moves, at least one vehicle datum (106) related to the structure of the at least one vehicle;
b) through said neural network (100), predicting an expected deceleration value (108) of the at least one vehicle, based on said at least one braking datum (102), at least one environmental datum (104), and at least one vehicle datum (106).

2. The method according to claim 1, comprising, before steps a) and b), performing training of the neural network (100);
wherein the training of the neural network comprises:
providing as input to said neural network at least one braking datum, at least one environmental datum, at least one vehicle datum and an expected deceleration value which is a function of said at least one braking datum, at least one environmental datum and at least one vehicle datum;
determining the value of at least one parameter of said neural network according to said at least one braking datum, at least one environmental datum, at least one vehicle datum and at least one expected deceleration value received.

3. The method according to claim 1, wherein said training is based on a “back-propagation” algorithm.

4. The method according to claim 1, wherein said neural network (100) comprises a feed-forward structure.

5. The method according to claim 1, wherein said at least one braking datum (102) related to performance of a braking system of the at least one vehicle comprises at least one of:
at least one deceleration datum indicative of a deceleration value of at least one wheel or at least one axle of the at least one vehicle;
at least one datum indicative of the number of wheels in the skidding phase of the at least one vehicle;
at least one datum indicative of the deceleration of the at least one vehicle in an initial stage of braking;
at least one datum indicative of an actuation speed of at least one braking means of the braking system;
at least one datum indicative of a skidding speed of the at least one wheel or the at least one axle of the at least one vehicle;
at least one datum indicative of a steady state value of at least one braking means of the braking system;
at least one datum indicative of an activation of a sanding means of the at least one vehicle;
at least one datum indicative of an activation of a magnetic braking pad of the at least one vehicle;
at least one datum indicative of an activation of a system/function arranged to compensate for a missed expected deceleration value;
at least one datum indicative of the presence of a malfunctioning braking means of the braking system;
at least one datum indicative of a number of activations over time of an exhaust valve associated with at least one braking means of the braking system of the at least one vehicle.

6. The method according to claim 1, wherein said at least one environmental datum (104) related to environmental conditions of a route along which the vehicle moves comprises at least one of:
at least one image datum or at least one video datum of the route;
at least one temperature datum indicative of a temperature along the route;
at least one rainfall datum indicative of the presence of rain along the route;
at least one moisture datum indicative of a moisture level along the route;
at least one adhesion datum indicative of a level of adhesion along the route;
at least one route datum of indicative of a profile of the route.

7. The method according to claim 1, wherein said at least one vehicle datum (106) related to the structure of the at least one vehicle comprises at least one of:
at least one nominal deceleration datum indicative of a nominal deceleration value of the at least one vehicle;
at least one wheel/axle datum indicative of the number of wheels or axles of the at least one vehicle;
at least one sanding means datum, indicative of the number of sanding means of the at least one vehicle;
at least one datum of magnetic pads, MTB, indicative of the number of magnetic brake pads of the at least one vehicle;
at least one anti-skid system datum, indicative of the fact that an anti-skid system, WSP, acts per vehicle bogie or per vehicle axle;
at least one datum of presence of deceleration compensation, indicative of the fact that the vehicle comprises a missed-deceleration compensation system/function of the at least one vehicle.

8. The method according to claim 1, wherein, when there is a plurality of types of braking data related to performance of a braking system of the at least one vehicle, the braking data of each type are respectively subjected to a data consolidation procedure before being provided to the neural network; and/or
when there is a plurality of types of environmental data related to environmental conditions of a route along which the vehicle moves, the environmental data of each type are respectively subjected to a data consolidation procedure before being provided to the neural network; and/or
when there is a plurality of types of vehicle data relating to the structure of the at least one vehicle, the vehicle data of each type are respectively subjected to a data consolidation procedure before being provided to the neural network.

9. The method according to claim 8, wherein the data consolidation procedure comprises at least one of:
the determination of an overall sum of the data, the determination of an average of the data, the determination of an absolute minimum among the data, the determination of an absolute maximum among the data.

10. A system for predicting an expected deceleration of at least one vehicle, particularly at least one railway vehicle, comprising at least one computer (101) arranged to carry out the method according to any of the preceding claims.

11. The system according to claim 10 for predicting an expected deceleration, wherein said computer is arranged to receive, from a communication means of the at least one vehicle, the at least one braking datum related to performance of a braking system of the at least one vehicle, the at least one environmental datum related to environmental conditions of a route along which the vehicle moves, and the at least one vehicle datum related to the structure of the at least one vehicle, to be provided to the neural network.

12. The system according to claim 10 for predicting an expected deceleration, wherein said computer is arranged to receive, from a control means of an additional vehicle transiting the route, the at least one braking datum related to performance of a braking system of the at least one vehicle, the at least one environmental datum related to environmental conditions of a route along which the vehicle is moving, and the at least one vehicle datum related to the structure of the at least one vehicle, to be provided to the neural network.

13. The system according to claim 10 for predicting an expected deceleration, wherein said computer is arranged to receive, from a control system of the at least one vehicle, the at least one braking datum related to performance of a braking system of the at least one vehicle, the at least one environmental datum related to environmental conditions of a route along which the vehicle moves, and the at least one vehicle datum related to the structure of the at least one vehicle, to be provided to the neural network;
the at least one braking datum related to performance of a braking system of the at least one vehicle, the at least one environmental datum related to environmental conditions of a route along which the vehicle moves, and the at least one vehicle datum related to the structure of the at least one vehicle being generated by the control system as a function of a predetermined adhesion map.
